(19) United States
(12) Patent Application Publication
(10) Pub. No.: US 2006/0044967 A1
(43) Pub. Date: Mar. 2, 2006

(54) Channel expansion communication system

(75) Inventor: Michio Yamamoto, Chiba (JP)

Correspondence Address: BACON & THOMAS, PLLC, 625 SLATERS LANE, FOURTH FLOOR, ALEXANDRIA, VA, 22314, US

(73) Assignee: Futaba Corporation, Chiba (JP)

(21) Appl. No.: 11/200,092

(22) Filed: Aug. 10, 2005

(30) Foreign Application Priority Data
Aug. 11, 2004 (JP) 2004-234431

(51) Int. Cl. G11B 19/02; G11B 5/09

(52) U.S. Cl. 369/47.1; 369/47.32

(57) ABSTRACT

In a channel expansion communication system for transmitting control data to remotely control a controlled object through a plurality of control channels which are allocated time-divisionally in one frame, the communication system includes an expansion encoder which forms expansion control channels corresponding to a plurality of the control data by timely dividing one of the control channels and an expansion decoder for recovering the incoming control data of the expansion control channels transmitted through the expansion encoder, wherein the control data transmitted through the expansion control channel in one frame is compressed in format while changed control data is outputted first.

### FIELD OF THE INVENTION

The present invention relates to a remote control system for remotely controlling target objects based on control data transmitted on radio wave etc. and, more particularly, to a channel expansion communication system which transmits and receives a greater number of control data through an expanded channel.

### BACKGROUND OF THE INVENTION

As the radio-control technology (hereinafter, referred to as ‘remote control’) which remotely controls a moving apparatus or device via a radio signal with control information has been provided, systems and methods for remotely controlling moving object such as a model vehicle or ship as a controlled object, have become commonly available.

A flying object or otherwise nearly a full-scale remote controlled object would require multiple remote control data, and accordingly, control channels are allocated time-divisionally to correspond thereto.

FIG. 5A shows a schematic block diagram of a transmitter of a radio control device. Reference numeral 1 is a control tool for controlling a flying object or ship or the like, as a controlled object, which comprises n joy sticks (showing in case of n=4) or several user controlled switches 1a to 1d.

Output control signals from the control tool 1a to 1d are inputted to each CH of an encoder 2 which outputs a pulse sequence having a predetermined frame period by converting a plurality of control signals.

At all times during the control, the pulse sequence composed of predetermined frames is modulated in modulator 3 with a carrier signal, and the modulated signal, for example, AM modulated or FM modulated wave, is provided to a RF amplifier 4 (transmit unit) to be transmitted to the controlled object.

FIG. 5B shows a pattern of pulse sequence composed of frames, which is outputted from the encoder. Signals for several different operations of a controlled object, for example, control of turning, control of ascent and descent, control of speed, and other controls, are converted into pulse signals CH1, CH2, CH3, CH4 . . . by channels 1, 2, 3, 4 . . . , respectively. The pulse sequence has continuously repeating frame formats wherein each frame period is in a range of, e.g., 14 ms to 20 ms.

Further, more specifically, the intervals of each pulse signal, CH1, CH2, CH3 . . . are varied in accordance with multiple control information. For example, the interval of each pulse indicates the pulse width, and each pulse width is varied depending on each control information having a different control value within the range from 880 μs to 2160 μs. The modulated width varies within ±640 μs (within 60 degrees which is the rotation angle of an actuator) based on an intermediate timing of 1520 μs as neutral point. Further, a synchronizing signal (logic low signal) longer than 5 ms is generated at the end of each frame to indicate the terminal point of each frame.

The control information as described above is continuously transmitted to the controlled object on waves. The controlled object which is the receiving side receives and demodulates incoming waves by using, e.g., a Superheterodyne receiver. In the decoder which processes the demodulated signals, serial control signals which are transmitted from the transmitter is converted into parallel control signals and then each parallel control signal of each channel is delivered to a servo motor which has a self control circuit or an actuator.

FIG. 6A describes a schematic block diagram of a decoder which converts a demodulated pulse position modulated (PPM) pulse sequence into parallel control signals for each channel. The decoder is composed of a reset circuit and D flip-flop circuits wherein reference numeral 31 is a reset circuit which generates detected outputs of synchronizing signals, and reference numerals 32, 33, 34 and 35 are D flip-flop (DFF) circuits.

The demodulated PPM pulse sequence is inputted into the respective DFF circuits 32, 33, 34 and 35 which form a shift register as clock signal and also into the reset circuit 31.

When the reset circuit 31 detects approximately 5 ms duration that the demodulated PPM pulse logic level is considered low, it generates a reset signal R whose output logic level is high and then the signal is delivered to D input of the first DFF 32 in the shift register. Thereafter, a successive pulse sequence is delivered to the shift register in order, as shown in FIG. 6B, so that control pulse signals CH1, CH2, CH3, CH4 . . . corresponding to each pulse interval of pulse position modulated pulse (PPM) signals can be outputted as parallel signals at the respective outputs of the register.

In addition, in case of upgrading the version of controlling contents of the controlled object, there is a channel expansion apparatus for simply expanding the control channel data outputted from the conventional encoder 2.

FIG. 7 provides a schematic block diagram of a transmitter having the channel expansion function, wherein the same reference numerals are used to indicate the same elements in FIG. 5A.

In this case, for example, a main encoder 5 which processes control signals of 4 channels is provided with an expansion encoder 6 which expands control data of the control channel CH4.

Further, control signals of a control tool 7 (7a to 7d) are provided to the expansion encoder 6. Then, the control signals of each control tool 7 are time-divisionally allocated to the additional channels (hereinafter, referred to as ‘expansion channels’) MP1 to MP4 to be outputted as expanded data of the original channel CH4.

As illustrated in FIG. 8, regarding control data outputted from the transmitter having the channel expansion function described above, a control pulse signal of the expansion control channel MP1 in the channel timing of CH4 is sequentially outputted with control pulse signals of the channels CH1, CH2 and CH3 in the first frame 1F. In the next frame 2F, a control pulse signal of the expansion control channel MP2 is sequentially outputted with control pulse signals of the channels CH1, CH2 and CH3.

In the same manner, a control pulse signal of the expansion control channel MP3 is outputted in the channel timing of CH4 of the third frame 3F, and a control pulse signal of expansion control channel MP4 is outputted in the fourth frame 4F. Moreover, a synchronous pulse SYN representing synchronous data is outputted in the last frame 5F after each control pulse is transmitted via the respective expansion channels MP1 to MP4 in order.

Consequently, 7 control data of the channels CH1, CH2 and CH3 and the expansion channels MP1 to MP4 can be transmitted to the controlled object after 5 fields since control data of the expansion channels MP1 to MP4, and SYN pulse for synchronizing are allocated sequentially in the channel timing of CH4.

In addition, the synchronous pulse SYN can be formed by a signal which is not outputted as a usual manipulation signal.

According to the channel expansion system described above, since the control channel can be expanded easily by employing an expansion encoder 6 to the conventional radio control transmitter, the transmitter becomes more useful. However, the responsiveness of the controlled object which receives the data is much worse than the responsiveness of a manipulation which is controlled using ordinary channels CH. This is because manipulation data of each expanded control channel (expansion channels MP1 to MP4) is transmitted once every several frames, every 5 frames in the above case.

For example, when each frame duration is set to last several tens of milliseconds, the controlled object could respond even several seconds later to a motion manipulation of the controller as for the control data of the expansion channel. Thus, this delay in response results in poor control capability.

### SUMMARY OF THE INVENTION

The present invention provides a channel expansion communication system which overcomes many of problems of the prior art.

It is, therefore, an object of the present invention to provide a channel expansion communication system for transmitting control data to remotely control a controlled object through a plurality of control channels which are allocated time-divisionally in one frame, the communication system comprising: an expansion encoder which forms expansion control channels corresponding to a plurality of the control data by timely dividing one of the control channels; and an expansion decoder for recovering the incoming control data of the expansion control channels transmitted through the expansion encoder, wherein the control data transmitted through the expansion control channel in one frame is compressed in format while changed control data is outputted first.

In accordance with the preferred embodiment of the present invention, when there is more than one changed control data, the control data transmitted through the expansion control channels has a longest waiting time among the changed control data if the respective waiting times of the changed control data are measured since their last outputs.

In accordance with another preferred embodiment of the present invention, the expansion encoder or the expansion decoder is connected to one of main channels formed of a main encoder or a main decoder which forms control channels respectively.

In accordance with still another preferred embodiment of the present invention, the control data provided to the control channels and the expansion channels is remote control data for controlling a model mobile object.

In accordance with still another preferred embodiment of the present invention, the expansion decoder outputs fail-safe data if the control data for the expansion control channel is determined as abnormal.

When there is more than one changed control data, the control data transmitted through the expansion control channels has a longest waiting time among the changed control data if the respective waiting times of the changed control data are measured since their last outputs. As a result, that the overall responsiveness is not degraded for the expansion channel.

Further, the encoder includes the main encoder, which forms the control channel, and the secondary encoder (expansion encoder), which is connected to one of the channels formed by the main encoder. Therefore, an increase in transmitted control data can be dealt with by using a transmitter at low costs. In particular, it can be useful for a radio communication system of remote control.

Further, by assigning a data region for fail-safe data when forming an expansion channel, safety can be maintained even though control is interrupted by an abnormal communication error.

### BRIEF DESCRIPTION OF THE DRAWINGS

FIGS. 1A and 1B offer a schematic block diagram of a transmitter and a receiver in accordance with a channel expansion communication system as employed in the present invention.

FIGS. 2A to 2C depict output timing of control data in each main channel CH and in each expansion channel MP.

FIG. 3 is a flow diagram illustrating the operation of a microcomputer for selecting and outputting control data delivered to the expansion channel MP.

FIG. 4 is a schematic block diagram of an expansion decoder for recording and storing control data which is inserted into the expansion channel to distribute it to respective actuators.

FIG. 5A presents a functional schematic block diagram of a transmitter for outputting a remote control data.

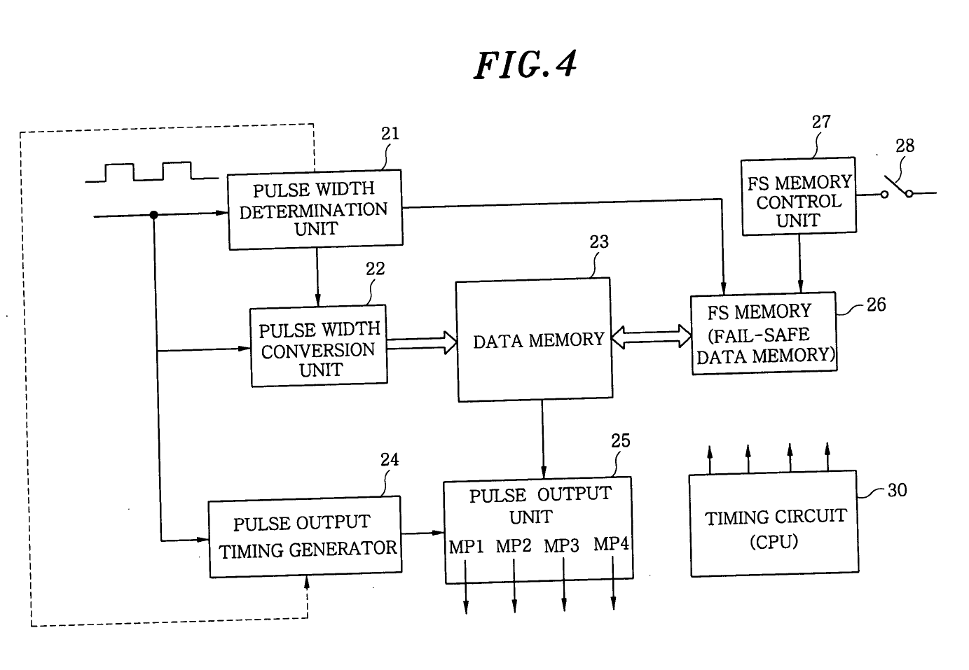

FIG. 5B is a pattern of a pulse sequence comprised of frames, outputted from the encoder.

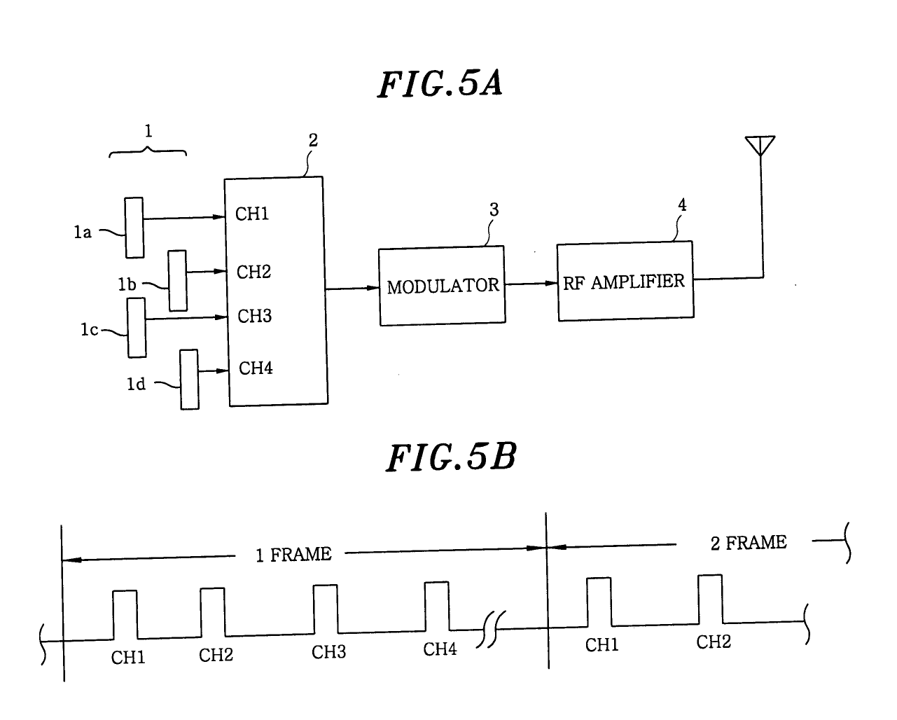

FIG. 6A is a schematic block diagram of a decoder for converting a pulse position modulated (PPM) pulse sequence into the pulse width modulated (PWM) parallel data and FIG. 6B describes the waveform thereof.

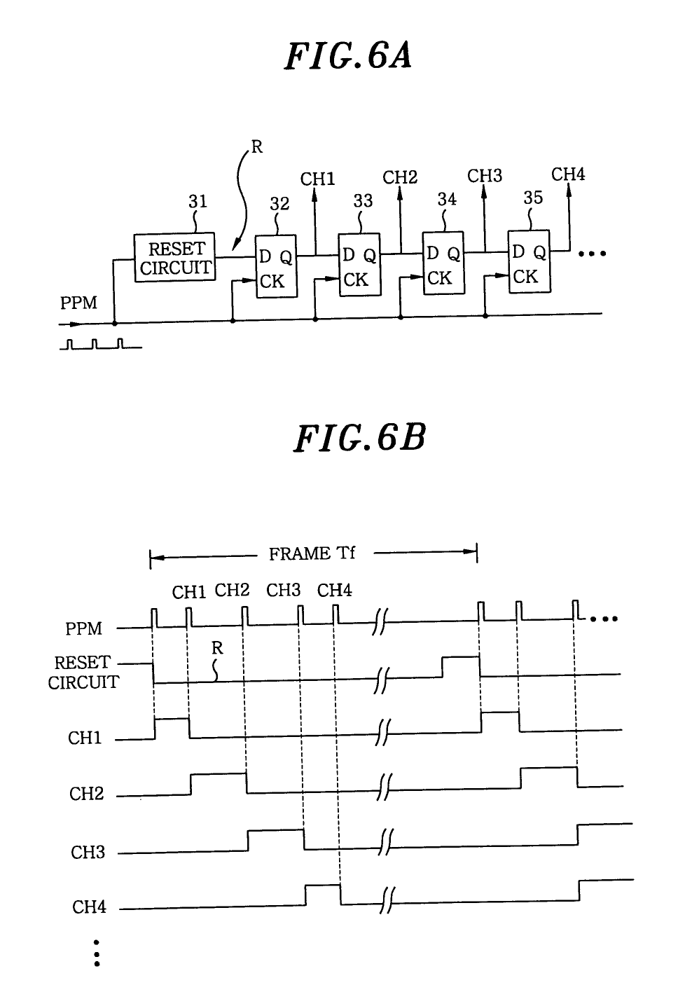

FIG. 7 provides a schematic block diagram of a transmitter for expanding control data.

FIG. 8 depicts output timing of the control pulse sequence from the main channel and expansion channel.

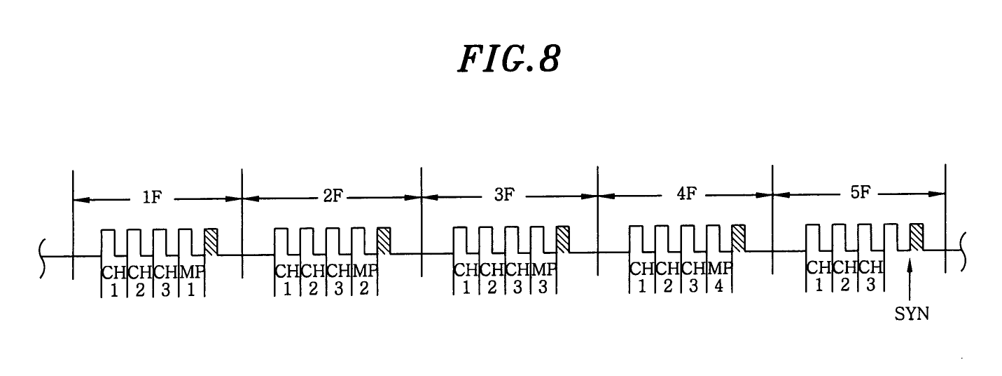

### DETAILED DESCRIPTION OF THE PREFERRED EMBODIMENT

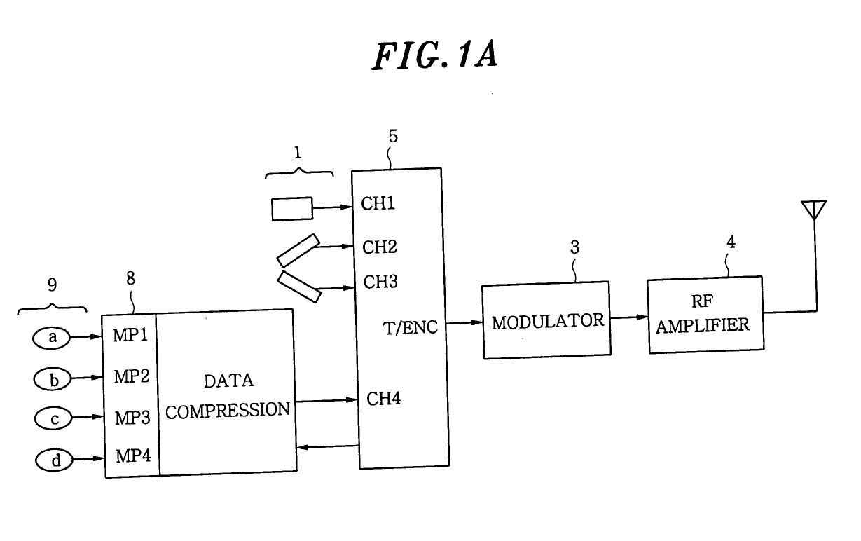

Preferred embodiments of the present invention will be described in detail with reference to the accompanying drawings. FIGS. 1A and 1B show an embodiment of a communication system according to the present invention in case of m main channels (e.g. m=4) and n expansion channels (e.g. n=4). FIGS. 1A and 1B offer a schematic block diagram of a transmitter and a receiver according to a channel expansion communication system employed in the present invention.

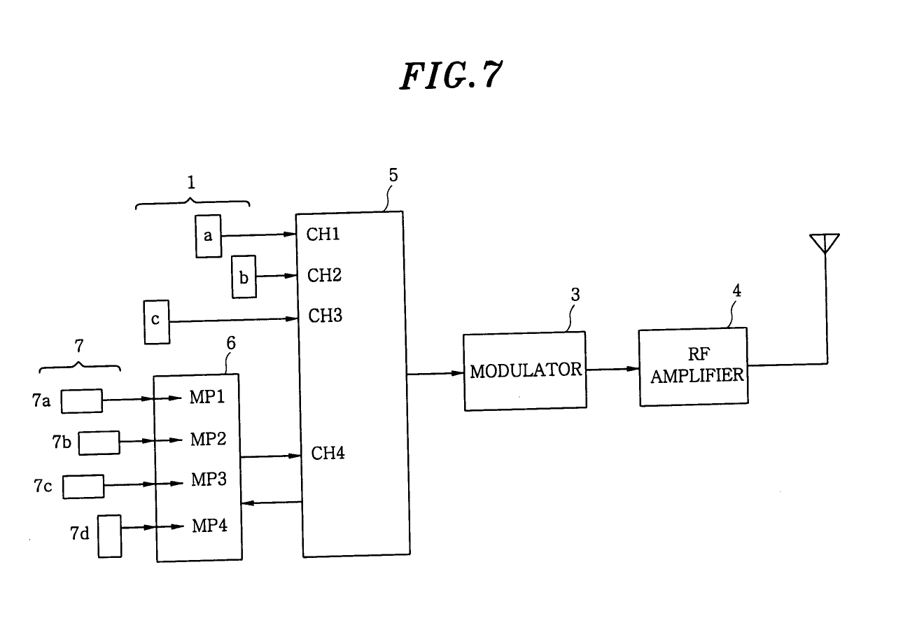

In the transmitter as shown in FIG. 1A wherein the same reference numerals are used to indicate the same elements in FIG. 7, there is a characteristic in that control data outputted from an encoder 8 is compressed data of the prior art control value. In addition, a manipulation tool 9 (a to d) for the expansion channel relates to manipulation data which varies less than control data delivered to the control channels CH1 to CH3.

Further, in the receiver installed in the controlled object, reference numeral 10 includes a radio frequency signal processing part which receives a wave having radio data, for example, a Superheterodyne receiver section which amplifies and converts radio frequency to demodulate.

While reference numeral 11 indicates a decoder which outputs pulse-width modulated control data separately per each CH1 to CHm (e.g. m=4), reference numeral 12 indicates a driving circuit (D1 to D3) which drives an actuator 13 (A1 to A3) actuated by control data of each channel, which is converted into parallel signals by the decoder 11.

Timing output of the channel CH4 in the decoder 11 is provided to an expansion decoder 14. The expansion decoder 14 generates control data of the expansion channels MP1 to MPn (e.g. n=4) in the parallel form of output. In other words, the expansion decoder 14 includes the functions of detecting a synchronizing signal and identifying the expansion channels, for example, MP1 to MP4, which are added in the transmitter to output.

Further, control data of each expansion channel outputted from the expansion decoder 14 is provided to respective actuators 16 (M1 to M4) via respective driving circuits 15 (D5 to D8).

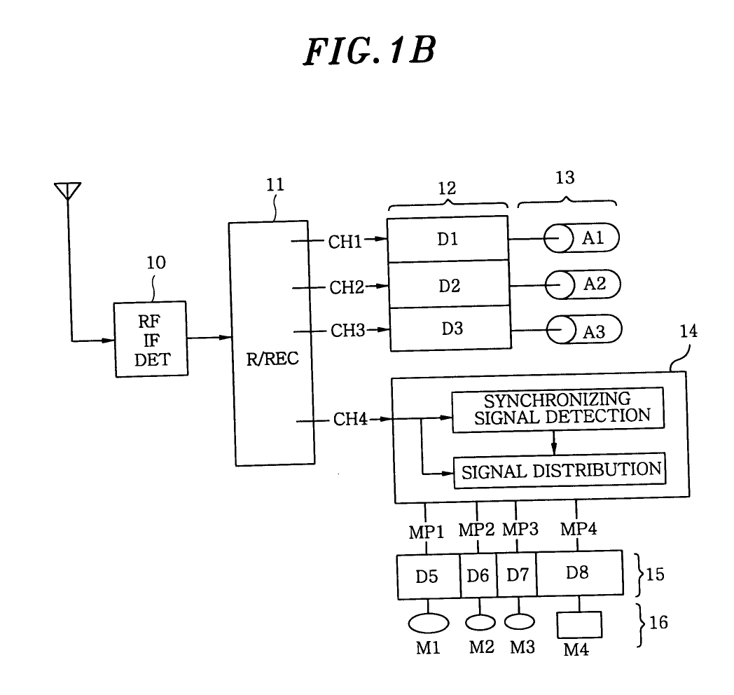

FIGS. 2A to 2C show timing waveforms of pulse width modulated control data generated from each channel. There are shown timing waveforms of the main channel CH in FIG. 2A, the expansion channel MP in FIG. 2B and fail-safe data for preventing an abnormal operation in FIG. 2C.

The pulse width duration Tw, e.g., in the range from 880 μs to 2160 μs (1280 μs) is assigned as a part which can be modulated in each main channel CH. Modulated width varies within ±640 μs based on intermediate timing 1520 μs as neutral point. This numerical value can be varied freely by means of each controller.

Additionally, as illustrated in FIG. 2B, as an example of expansion channels MP1 to MP4 according to the present invention, 4 kinds of control data being compressed to 25 percent of its original size is generated as an output pulse signal with time duration Tw which is almost the same as the main channel CH.

In other words, 4 modulated regions are allocated to the respective expansion channels, e.g., the range from 880 μs to 1180 μs for the MP1, the range from 1120 μs to 1520 μs for the MP2, the range from 1560 μs to 1860 μs for MP3 and the range from 1900 μs to 2100 μs for MP4.

Further, a ruled line (bold line) indicates an adjacent region of each expansion channel which is inactive pulse width 40 μs in order to facilitate detection of expansion channel.

Furthermore, as shown in FIG. 2C, in the last region FS from 2140 μs to 2160 μs, a region for fail-safe data which is formed when there is a communication error, e.g., receiving error to be generated from the receiving side, is assigned.

In accordance with the present invention, particularly, data provided to the expansion channels MP1 to MP4 is not control data which is required from the controlled object frequently or all the time, but control data which does not change with time frequently so that this results in improved responsiveness.

For example, in case that the controlled object is a flying object, it may be preferably used for controlling a needle of an engine or a retractable wheel for take off or landing. It may be also used for controlling a lift crane or a whistle or manipulating of anchoring in case of a model ship.

From the foregoing, the expansion channel MP is assigned by dividing time zone (time slot) Tw of the main channel CH by a number n of the expansion channel and applying an offset value Tof as a center of modulation. Here, as shown in FIG. 2B, Tof(K) as an offset value of each expansion channel MP can be written for K=1, 2, 3 . . . , n (n indicates the number of the expansion channel) as an equation (1):
Tof(K)=Tw/2n+(K−1)*Tw/n (1)

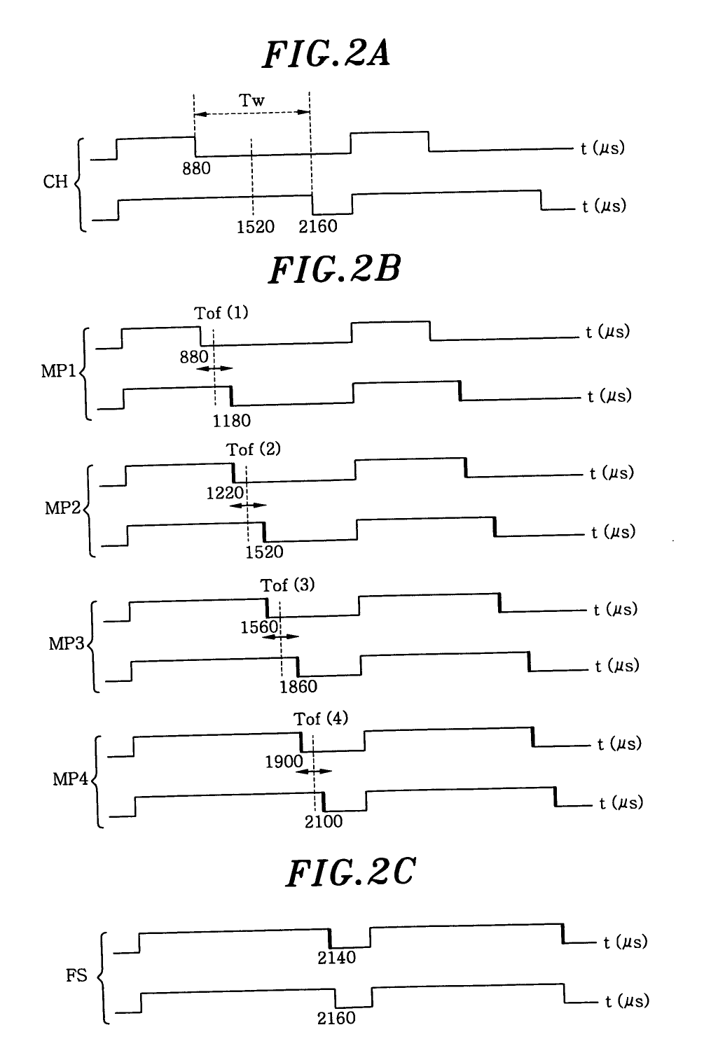

Next, FIG. 3 illustrates that in which timing mode the expanded manipulation data should be outputted and transmitted in an output of the expansion encoder of the transmitting side.

A CPU (microcomputer) controlling the output timing of the channel data on the transmitting side continuously monitors the input state (whether data changes or not) and waiting state (how long time when data does not change passes) of the control data which is provided to the expansion channels MP1-MP4 by using its timer function in step S1. In step S2, it decides whether non-manipulated time passes over predetermined time.

Thus, if the time goes over the predetermined time, control data representing manipulation value of the expansion channel in which the time is over, is selected in step S3 to be outputted at the corresponding expansion channel. Besides, in step S10, after waiting time of the channel in which the time is over is reset to zero, the step goes back to the start point.

If the time passes over the predetermined time, it is decided whether or not all the expansion channels MPs are non-manipulated in step S4.

Further, even though the time does not go over the predetermined time, if there is no data change in step S4 on the ground that all the expansion channels MPs are non-manipulated, control data which has a maximum waiting time (from the last data change time to the present time) of the expansion channels MP1 to MP4, is selected and thereby the present manipulation data status of the selected channel is outputted in step S5.

Furthermore, if there is a manipulated expansion channel in step S4, the manipulated expansion channel is extracted in step S6. In step S7, it is decided whether the extracted channel has a plurality of manipulated expansion channels. If there is a plurality of manipulated expansion channels, the control data which has a maximum waiting time among the expansion channels at that time is outputted in step S9 first and then the waiting time of the channel is reset to zero in step S10. Otherwise, if there is only one manipulated expansion channel, control data of the manipulated expansion channel is outputted in step S8.

Accordingly, while control data of expansion channels MP1 to MP4 changes, e.g., while the expansion channel where control data changes is MP1, control data of MP1 is preferentially outputted in each frame to be transmitted to the controlled object as a control signal.

If then control data of the expansion channel MP1 does not change any more and another expansion channel, e.g., control data of the channel MP2 changes, control data of MP2 is continuously outputted in each frame.

Further, when none of control data of all expansion channels MP1 to MP4 are changed, data representing manipulation value of control data which has a maximum waiting time (control data whose change was done in the longest time ago) is selected to be outputted.

Therefore, in this case when there is no change of control data in any expansion channel, control data of one of the expansion channels MP1 to MP4 is outputted in each frame by following the order in which control data has a maximum waiting time.

In this manner, on the controlled object side as will be described below, manipulation value can be refreshed at the predetermined timing in the memory means although there is no change of control data.

In contrast, control data in the ordinary channels CH1 to CH3 is always transmitted in each frame.

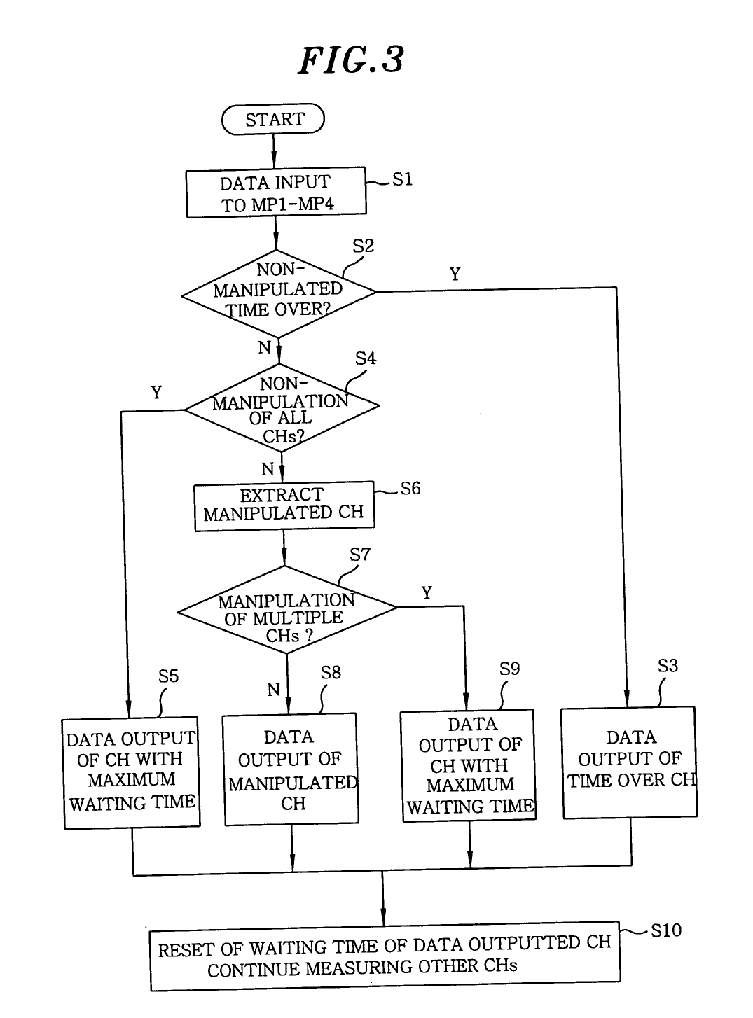

FIG. 4 is a schematic block diagram of a preferred embodiment of an expansion decoder. A pulse width determination unit 21 determines which expansion channel the input signal belongs to by using the timing as illustrated in FIGS. 2B and 2C.

For example, as shown in FIG. 2B, if a time duration (time slot) of each expansion channel has been formed, it is determined which expansion channel of Mp1 to MP4 is detected as a control pulse signal in the pulse width determination unit 21.

Further, by receiving the control pulse signal from a main decoder and information about which expansion channel the received control pulse signal belongs to from the pulse width determination unit 21, a pulse width conversion unit 22 detects pulse width of the control pulse signal and converts it into pulse width of control data of the corresponding expansion channel and, thereby, records it into a data memory 23.

For example, as shown in FIG. 2B, if a received pulse signal is about MP1, conversion into the pulse width of control data is performed by subtracting the minimum pulse width 880 μs from the received pulse signal and then expanding it 4 times to be added with the minimum pulse width 880 μs of the main channel. In case of MP2, the minimum pulse width 1220 μs is subtracted from the received pulse signal and then it is expanded 4 times to be added with the minimum pulse width 880 μs of the main channel. In case of MP3, a pulse width conversion unit 22 converts the pulse width of the received control pulse signal into the pulse width of control data of the expansion channel MP3 by subtracting the minimum pulse width 1560 μs from the received pulse signal and then expanding it 4 times to be added with the minimum pulse width 880 μs of the main channel. Further, in case of MP4, the minimum pulse width 1990 μs is subtracted from the received pulse signal and then it is expanded 4 times to be added with the minimum pulse width 880 μs of the main channel.

In these cases, each pulse width of converted control data of the expansion channels MP1 to MP3 having a modulated region of 300 μs is between 880 μs and 200 μs while the pulse width of converted control data of the expansion channel MP4 having 200 μs from 1900 μs to 2100 μs as a modulated region is between 880 μs and 1680 μs. Therefore, the maximum pulse width of converted control data may not be equal to 2160 μs while the pulse width of converted control data is in the range from 880 μs to 2160 μs. It is due to that the pulse width of control data of the respective expansion channels MP1 to MP4 can be changed freely depending on respective control parts' setting.

In another embodiment, a modulated region can be allocated equally to each expansion channel MP1 to MP4. For example, if a modulated region of CH4 is in the same range from 880 μs to 2160 μs as main channel, pulse width of 275 μs is assigned equally as a modulated region. Further, inactive pulse width of 40 μs is allocated inbetween respective channels while the last region from 2140 μs to 2160 μs is allocated for fail-safe data which is generated from the receiving side. Therefore, 4 modulated regions are allocated to the respective expansion channels, e.g., the range from 880 μs to 1155 μs for the MP1, the range from 1195 μs to 1470 μs for the MP2, the range from 1510 μs to 1785 μs for MP3 and the range from 1825 μs to 2100 μs for MP4.

If the pulse width conversion unit 22 in the expansion decoder receives a control pulse signal and information about which expansion channel a received control pulse signal belongs to, it detects pulse width of the control pulse signal and converts it into pulse width of control data of the corresponding expansion channel by subtracting the minimum pulse width from the detected pulse signal and then expanding it 4 times to be added with the minimum pulse width 880 μs of the main channel. Therefore, all pulse width of converted control data of the expansion channels MP1 to MP4 is between 880 μs and 1980 μs. In this case, the respective control parts are set to be controlled by control data in the range from 880 μs to 1980 μs. Otherwise, pulse width of converted control data can be between 880 μs and 2160 μs if it is inflated approximately 4.655 times.

Further, the data memory 23 stores control data received from the pulse width conversion unit 22 or the FS memory 26.

The pulse output timing generator 24 generates pulse timing by reading the received input signal in order that the control data of the expansion channels MP1 to MP4 or FS data in the data memory 23 is read to be distributed to the corresponding actuator. In accordance with the present invention, the control data in the data memory 23 is distributed to the respective expansion channels MP1 to MP4 in a pulse output unit 25 to be outputted to the respective actuators in every frame.

Reference numeral 26 indicates the FS memory (fail-safe data memory). In the FS memory 26, data for assuring safety of the controlled object in advance is recorded from a FS memory control unit 27 by manipulation of a FS memory switch 28. For example, when the FS memory switch 28 is switched on, received data of channels MP1 to MP4 at that time is recorded in the FS memory 26.

Furthermore, for example, if the receiver can not receive any input signal for a while due to a communication error or if the main decoder in the receiver detects all data missing, fail-safe data of FS memory 26 is recorded in the data memory 23 by a signal provided from the pulse width determination unit 21 at the pulse signal output timing in FIG. 2C and then this data in the data memory 23 is outputted to the expansion channels MP1 to MP4.

Otherwise, the pulse width determination unit 21 can detect such a communication error and generate a pulse signal as shown in FIG. 2C, thereby, providing the signal to the pulse output timing generator 24 and FS memory 26 for safety of the controlled object.

A timing circuit 30 has a function for synchronizing all signals provided with a CPU.

While the invention has been shown and described with respect to the preferred embodiments, it will be understood by those skilled in the art that various changes and modification may be made without departing from the spirit and scope of the invention as defined in the following claims.

What is claimed is:

1. A channel expansion communication system for transmitting control data to remotely control a controlled object through a plurality of control channels which are allocated time-divisionally in one frame, the communication system comprising:
an expansion encoder which forms expansion control channels corresponding to a plurality of the control data by timely dividing one of the control channels; and
an expansion decoder for recovering the incoming control data of the expansion control channels transmitted through the expansion encoder,
wherein the control data transmitted through the expansion control channel in one frame is compressed in format while changed control data is outputted first.

2. The channel expansion communication system as claimed in claim 1, wherein when there is more than one changed control data, the control data transmitted through the expansion control channels has a longest waiting time among the changed control data if the respective waiting times of the changed control data are measured since their last outputs.

3. The channel expansion communication system as claimed in claim 2, wherein the expansion encoder or the expansion decoder is connected to one of main channels formed of a main encoder or a main decoder which forms control channels respectively.

4. The channel expansion communication system as claimed in claim 3, wherein the control data provided to the control channels and the expansion channels is remote control data for controlling a model mobile object.

5. The channel expansion communication system as claimed in claim 4, wherein the expansion decoder outputs fail-safe data if the control data for the expansion control channel is determined as abnormal.
